(19) United States
(12) Patent Application Publication
(10) Pub. No.: US 2018/0010759 A1
(43) Pub. Date: Jan. 11, 2018

(54) LIGHT-EMITTING ARRANGEMENT AND VEHICLE HEADLIGHT

(71) Applicant: OSRAM GmbH, Munich (DE)

(72) Inventors: Ricarda Schoemer, Zusmarshausen (DE); Oliver Hering, Niederstotzingen (DE); Norbert Haas, Langenau (DE); Stephan Schwaiger, Ulm (DE)

(21) Appl. No.: 15/641,353

(22) Filed: Jul. 5, 2017

(30) Foreign Application Priority Data
Jul. 5, 2016 (DE) 10 2016 212 199.5

(51) Int. Cl. F21S 8/10; B60Q 1/08

(52) U.S. Cl. CPC F21S 48/1757; F21S 48/1317; F21S 48/115; F21S 48/1136; B60Q 1/08; F21Y 2115/10

(57) ABSTRACT

In various embodiments, a light-emitting arrangement is provided. The light-emitting arrangement includes a radiation source, into the beam path of which a micromirror device is arranged via which radiation emitted by the radiation source may be directed at least into a first and a second direction, at least one further radiation source configured to emit radiation toward the micromirror device. The radiation from the further radiation source may be directed, via the micromirror device at least into a first and a second direction. The micromirror device is movable about at least one axis into at least two positions.

### CROSS-REFERENCE TO RELATED APPLICATION

This application claims priority to German Patent Application Serial No. 10 2016 212 199.5, which was filed Jul. 5, 2016, and is incorporated herein by reference in its entirety.

### TECHNICAL FIELD

Various embodiments relate generally to a light-emitting arrangement. Various embodiments furthermore relate to a vehicle headlight having a light-emitting arrangement.

### BACKGROUND

Vehicles have conventional vehicle headlights for illumination functions, such as for example a low beam function or high beam function. The vehicle headlights can here be configured in the form of an adaptive driving beam (ADB) or of an adaptive frontlighting system (AFS). Other conventional vehicles have what are known as night vision assistants (night vision system). Here, a distinction can be made between active and passive night vision assistants. In the case of an active night vision assistant, infrared radiation (IR radiation) is emitted by the vehicle, and IR radiation reflected by the environment is captured by a camera. An image thus obtained can be displayed, for example, on a head-up display of the vehicle. In the case of a passive night vision assistant, the vehicle does not emit IR radiation, which is why a camera of the vehicle captures only the IR radiation that is emitted by the environment itself. The image thus obtained can likewise be represented on a head-up display.

One effect here is that such illumination functions and night vision assistants result in significant outlay in terms of apparatus and are costly.

### SUMMARY

In various embodiments, a light-emitting arrangement is provided. The light-emitting arrangement includes a radiation source, into the beam path of which a micromirror device is arranged via which radiation emitted by the radiation source may be directed at least into a first and a second direction, at least one further radiation source configured to emit radiation toward the micromirror device. The radiation from the further radiation source may be directed, via the micromirror device at least into a first and a second direction. The micromirror device is movable about at least one axis into at least two positions.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 schematically shows a perspective illustration of part of a light-emitting arrangement according to a first embodiment;

FIGS. 2A and 2B show each schematically show a perspective illustration of the light-emitting arrangement according to the first embodiment; and

FIG. 3 shows a schematic illustration of part of the light-emitting arrangement according to a second embodiment.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

Various embodiments provide a light-emitting arrangement and a vehicle headlight that may be used for different or variable light-emitting functions in a manner that is simple in terms of apparatus outlay and is cost-effective.

According to various embodiments, a light-emitting arrangement having a radiation source or an illumination module is provided. Arranged in the beam path of the radiation source may be a micromirror device (digital micromirror device (DMD)) or a liquid-crystal-on-silicon (LCoS) device or a liquid crystal display (LCD) device. Radiation emitted by the radiation source may be directed by way of the device at least into a first and a second direction. In addition to the first radiation source, at least a further, second radiation source or illumination module may be provided. The radiation source here emits radiation toward the device, wherein the radiation may then likewise be directed by way of the device at least into a first or second direction. In various embodiments, the device as a whole can be movable, e.g. about at least one axis and/or one point, into at least two positions, e.g. pivot positions. The device can thus be moved toward the respective radiation source.

One effect of this solution is that the complex and high-resolution device (DMD, LCoS, LCD) is usable for multiple radiation sources, by way of simply moving it as a whole toward the respective radiation source. In other words, it may be provided from a technological and financial point of view to use the costly device for multiple or different or several types of illumination modules.

A movement of the device can be understood to mean, for example, pivoting about the axis and/or about the point, wherein the axis or the point can extend inside or outside the device or touch the device. Also feasible as a movement is panning or adjusting or setting or changing a position or tilting or rotating or twisting.

In a further configuration, a common optical unit or projection optical unit or coupling-out optical unit is provided for the radiation sources downstream of the device. It may be provided here for an angle or pivot angle between the positions of the device to be selected to be relatively small. In a further configuration, the common optical unit is adapted for different, e.g. for at least two, wavelength ranges. As a result, if the radiation sources emit electromagnetic radiation in different wavelength ranges, the projection optical unit can be used for both wavelength ranges.

Also feasible is the provision of the optical unit or the projection optical unit or the coupling-out optical unit in a manner in which it is movable or rotatable, in order to use them for two or more radiation sources.

Alternatively or additionally to the coupling-out optical unit, or alternatively or additionally to the movable coupling-out optical unit, a radiation combiner or beam combiner can be provided downstream of the device. The beam combiner can then be used to combine the radiation from the at least two radiation sources or from a multiplicity or all radiation sources (if more than two radiation sources are provided).

In various embodiments, in each case one optical unit or projection optical unit is provided downstream of the device for a respective radiation source. If more than two radiation sources are provided, in each case one optical unit can be provided at least for one part of the radiation sources, and, for example, one common optical unit for the other part. The optical units can differ in a further configuration, for example they can be adapted to their respective radiation sources. Consequently, a dedicated, independent optical unit can be provided for each radiation source having its light-emitting function in order to then project the radiation, for example, onto a lane or a road. Different optical units may have the effect that different light distributions may be formed, for example with respect to the angle space they cover or an aspect ratio.

At least one shield is advantageously provided in the light-emitting arrangement for blocking undesired radiation. The shield may be provided e.g. when using a plurality of optical units.

In a further configuration, the first radiation source is used for a first light-emitting function, and the second radiation source is used for a second light-emitting function. It is alternatively feasible for both radiation sources to be provided for the same light-emitting function.

By way of example, at least one of the radiation sources, e.g. the first radiation source, is provided for an illumination function or a signal-light function. The illumination function can be a turn-signal light function and/or a fog-light function and/or a low beam function and/or a high beam function and/or a combination of the above functions (for example adaptive driving beam (ADB) or adaptive frontlighting system (AFS)) and other functions. The signal-light function may be a blinking function and/or a brake light function and/or a rear light function and/or a daytime running light function and/or a position light function and/or a fog function and/or a combination of said functions and further functions.

If the device is then moved, for example, in its first position toward the first radiation source, the radiation therefrom can be used for the illumination function or a signal-light function or for a combination of illumination function and signal-light function, and be emitted, for example, into a vehicle environment.

At least one of the radiation sources, e.g. the second radiation source, may be used for a night vision function. The light-emitting arrangement can thus be used extremely cost-effectively for two light-emitting functions, specifically in this case the night vision function and a further light-emitting function, such as for example an illumination function or signal-light function.

The first radiation source and/or the second radiation source may emit radiation at least substantially within the visible range as their light radiation (VIS radiation). It is also feasible for the first radiation source and/or the second radiation source to emit radiation in particular in the adjoining ultraviolet range, in the form of UV radiation.

For the night vision function, provision may be made for one of the radiation sources, e.g. the second radiation source, or for both radiation sources to emit radiation at least substantially in the infrared range in the form of infrared radiation (IR radiation). The radiation can here be emitted in modulated or unmodulated form.

In a further configuration, a sensor, e.g. a camera or an infrared camera, is provided. This sensor can be used to capture IR radiation which is emitted by one of the radiation sources, e.g. by the second radiation source, or by both radiation sources and reflected by an environment.

If, for example, the first radiation source emits VIS radiation and the second radiation source emits IR radiation, it is possible for in particular the active night vision function to be used during darkness in addition to the normal headlight function, i.e. illumination function or signal-light function. To this end, one region of an environment of a vehicle using the light-emitting arrangement, specifically a front, side or rear region, can be lit, for example at regular intervals, with modulated or unmodulated IR radiation. Back-reflected IR radiation can then be captured by the IR camera. The information thus obtained can subsequently be processed further, for example by representing detected objects on a display in the vehicle interior for the driver and/or an adaptive driving beam (ADB) is regulated and/or for example automatic braking of the vehicle having the light-emitting arrangement takes place in the case of detected obstacles. By using the device, in particular in the form of a DMD, the radiation distribution of the IR radiation in the far field can be set in a targeted fashion. For example, in the case of oncoming traffic, a region of an IR camera of an oncoming vehicle can be masked out so as not to disturb infrared measurement of the oncoming traffic. Hitherto it has been typical, for example, for radiation sources emitting IR radiation to emit polarized radiation and for infrared cameras in the vehicle to detect only IR radiation that has been polarized by being rotated about 90° in order to avoid blinding the infrared camera. For this reason, only IR radiation that has been diffusely reflected at objects has hitherto been detected. The effect of the light-emitting arrangement having the adaptive light distribution of the IR radiation may thus be that a polarization filter can be omitted, for example. In addition, lower infrared intensities can be provided, and subsequently for example a lower number of and/or more cost-effective radiation sources for IR radiation can be used, since there is no need to arrange a polarization filter in the beam path of the radiation source emitting IR radiation or in front of the infrared camera. In addition or alternatively, it is feasible for no masking out of the oncoming traffic to take place or for additional radiation, for example IR radiation, to be provided in the case of oncoming traffic, and therefore vehicles of the oncoming traffic can additionally use the emitted radiation from the light-emitting arrangement and/or it can serve for better lighting for the subject vehicle or for one or more vehicles of the oncoming traffic.

In various embodiments, laser activated remote phosphor technology (LARP technology) is used for the first radiation source and/or for the second radiation source. In this technology, a conversion element, which includes or essentially consists of a phosphor and is arranged at a distance from the radiation source, is irradiated with excitation radiation, e.g. an excitation beam (pump beam, pump laser beam), e.g. with the excitation beam from a laser diode. The excitation radiation of the excitation beam is at least partially absorbed by the phosphor and at least partially converted by the phosphor into conversion radiation, whose wavelengths and thus spectral properties and/or color are determined by the conversion properties of the phosphor. In the case of down conversion, the excitation radiation from the radiation source is converted by the irradiated phosphor into conversion radiation having longer wavelengths than the excitation radiation. It is thus possible, for example, using the conversion element to convert blue excitation radiation (blue laser light) into red or green or yellow conversion radiation (conversion light).

It is likewise feasible for the first radiation source and/or the second radiation source to be used as a light-emitting diode (LED). An LED or light-emitting diode can be present in the form of at least one individually packaged LED or in the form of at least one LED chip having one or more light-emitting diodes. A plurality of LED chips can be mounted on a common substrate (“sub-mount”) and form an LED or be fixed individually or together for example on a printed circuit board (e.g. FR4, metal core PCB etc.) (“CoB”=chip-on-board). The at least one LED can be equipped with at least one dedicated and/or common optical unit for beam guidance, for example with at least one Fresnel lens or a collimator. Instead of or in addition to inorganic LEDs, for example on the basis of AlInGaN or InGaN or AlInGaP, generally organic LEDs (OLEDs, e.g. polymer OLEDs) may also be used. The LED chips can be directly emitting or have a phosphor upstream. Alternatively, the LED can be a laser diode or a laser diode arrangement. Also feasible is an OLED light-emitting layer or a plurality of OLED light-emitting layers or an OLED light-emitting region. The emission wavelengths of the LED can be in the ultraviolet, visible or infrared spectral range. The LEDs can in addition be equipped with their own converter. The LED chips preferably emit white light in the standardized ECE white field of the automotive industry, for example implemented in the form of a blue emitter and a yellow/green converter.

It is furthermore also feasible for the first radiation source and/or the second radiation source to be configured in the form of a halogen lamp and/or a gas discharge lamp (HID).

If for example radiation sources having LARP technology are provided as the radiation sources, they can have different conversion elements. If the radiation sources are configured in the form of LEDs, they have, for example, different colors or different conversion elements, which can result in different colors. The result of this can be that one of the radiation sources exhibits warm white radiation and the other radiation source exhibits cold white radiation, or one radiation source exhibits white radiation and the other radiation source exhibits orange radiation. White radiation is usable, for example, for the illumination function, and orange radiation is usable for the signal-light function (indicator). It is also feasible for the radiation sources to have combinations of colors that are typical in the automotive field, with these colors being white shades, yellow, orange, red or blue. Radiation distributions having different light colors can thus be projected for example into a far field. The device, e.g. in the form of a DMD, may be panned between its positions with a minimum speed or frequency such that active color correction of the radiation distribution in the far field is made possible. In radiation sources having LARP technology and/or in the case of LEDs, different colors can be made possible by way of different phosphor proportions in the conversion elements.

The radiation from the radiation sources may have electromagnetic spectra that differ from one another.

As has already been explained above, the device can be moved or switched at least into its first and second position or pivot position. In the first position, a first light-emitting function can be made possible, and in the second position, a second light-emitting function can be made possible. If a plurality of further positions are provided, further light-emitting functions can also be used. It is, for example, feasible to use an indicator as a light-emitting function and use a daytime running light as a further light-emitting function.

In a further configuration, the device can be moved or switched between the positions with a frequency or speed such that a plurality of light-emitting functions or radiation sources may be used approximately simultaneously, in particular in a quick time sequence. The frequency can be, for example, greater than or equal to 60 Hz, greater than or equal to 100 Hz, greater than or equal to 200 Hz, greater than or equal to 400 Hz or above, or a frequency can be in the frequency range of between 60 Hz and greater than or equal to 400 Hz. The frequency or speed is preferably chosen such that a switch between the light-emitting functions cannot be perceived by the human eye. In other words, the device is moved or switched quickly and multiple times, for example at frequencies above the perception of the human eye, with the result that a plurality of light-emitting functions and/or radiation sources are active “simultaneously.”

The first radiation source may be switched on only in the first position of the device, and the second radiation source only in the second position of the device. Consequently, the radiation sources can be used in pulsed mode. This leads to a lower average power as compared to two permanently switched-on radiation sources. It is also feasible for one of the radiation sources or both radiation sources to be subjected to overcurrent in a targeted manner so as to additionally increase the luminance—and thus the light flux.

In various embodiments, the sensor is activated only together with one of the radiation sources and/or only in one of the positions. The sensor may be activated if the radiation source that emits the radiation (IR radiation) that the sensor is able to receive is activated. This provides the possibility of synchronization with the sensor, as a result of which for example the light-emitting function for the sensor and the sensor are briefly active for example only every one tenth of a second (10 Hz), since this is sufficient, for example, for the night vision function.

In other words, the light-emitting arrangement according to various embodiments provides a DMD system or an LCD system or an LCoS system in which the system as a whole can be moved or pivoted or rotated or tilted in order to be provided by the same or a plurality of possibly different or identical illumination modules with electromagnetic radiation, e.g. in the visible range and/or the adjoining UV range and/or in the infrared range.

The device may be movable about a further axis and/or about a further point—e.g. in a respective position of the device—in order to move an emission surface of the device. The further axis here for example at least approximately coincides with a radiation axis of the first radiation source, e.g. in the first position, and/or with a radiation axis of the second radiation source, e.g. in the second position. In other words, in further configurations, the device, in particular in the form of a DMD, can be pivoted about its own axis, which results in a tilting of the emission plane. It is possible hereby, when using the same radiation source, to generate a different emission profile, which is then usable with the same or a different optical unit.

As has already been explained above, the device can also switch between more than two positions. Consequently, more than two radiation sources can thus also be used in alternation by way of the device, for example in the form of a DMD, for illumination, for example of a half space in front of the vehicle.

In various embodiments, the entire area or part of the area of the device, e.g. in the form of a DMD, is illuminated by one of the radiation sources or by both radiation sources. The radiation sources can furthermore have different outputs and operating modes (continuous/cw, or pulsed/timed).

The micromirror device may have at least one micromirror which is actively movable, e.g. pivotable, at least into a first position or pivot position (on state) and into a second position or pivot position (off state) about its at least one axis or pivot axis in its specified angle range or pivot angle range or acceptance angle range. The radiation emitted by the radiation source, toward which the device is directed, can then, in the first position of the micromirror, be reflected thereby toward a radiation exit of the light-emitting arrangement.

The beam combiner is arranged preferably such that in both positions of the device, in each case in the first position (on state) of the micromirror, it combines the reflected radiation. Alternatively or additionally, it is feasible for an optical unit or a secondary optical unit to be provided for a respective radiation source.

In addition to the radiation sources for the positions of the device, it is possible for at least one further radiation source to be provided in one or a respective position of the device, whose emitted radiation radiates toward the device, e.g. toward the micromirror of the device. For example, a radiation source can thus be used for a light-emitting function in the first position (on state) of the micromirror, and the further radiation source can be used for a light-emitting function in the second position (off state) of the micromirror.

According to various embodiments, a vehicle headlight for a vehicle having a light-emitting arrangement according to one or more of the preceding aspects is provided. Such a vehicle headlight can have a plurality of light-emitting functions in a manner which is simple in terms of apparatus and is cost-effective.

The vehicle can be an aircraft or a water-bound or a land-bound vehicle. The land-bound vehicle can be a motor vehicle or a rail vehicle or a bicycle. It may be provided to use of the vehicle headlight in a truck or a passenger vehicle or a motor bicycle.

The applicant furthermore reserves the right to direct one claim to a vehicle having a vehicle headlight of this type or a light-emitting arrangement of this type according to one or a plurality of the preceding aspects.

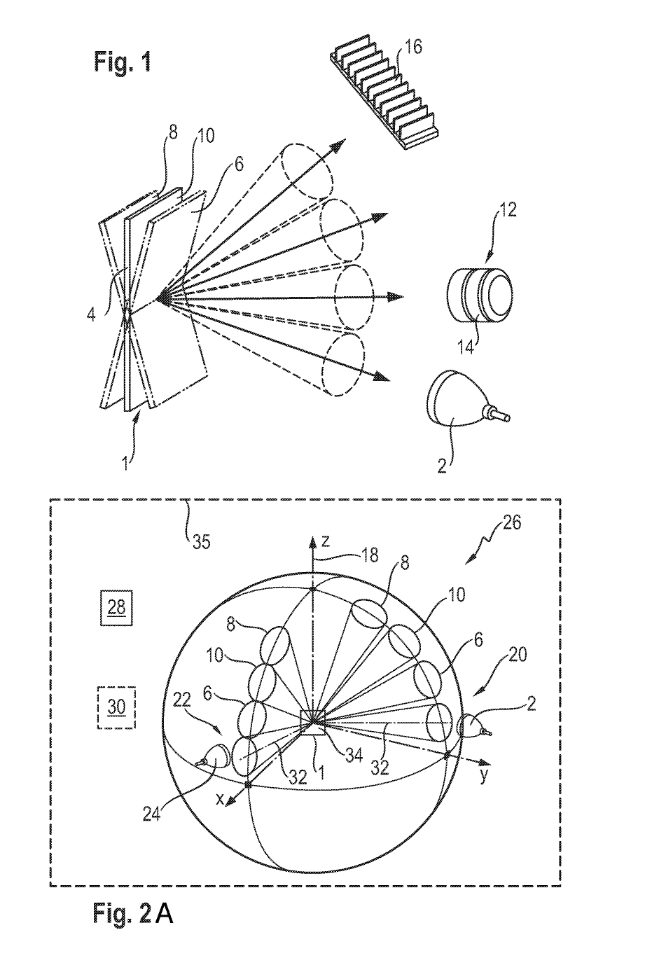

FIG. 1 shows a micromirror device 1 of a light-emitting arrangement for a vehicle. The light-emitting arrangement has a radiation source 2, which emits radiation toward a micromirror 4. The micromirror device 1 typically has a multiplicity of micromirrors 4, wherein FIG. 1 shows only one micromirror 4 for the sake of simplicity. The micromirrors 4 can be actuated individually or be moved or switched between two defined end tilt positions. The radiation source 2 emits the radiation here in the shape of a cone, with the cone tapering toward the micromirror 4. The micromirror 4 is movable into a first position (on state) 6 and into a second position (off state) 8. Provided between the two positions 6 and 8 is a third position (flat state) 10 that the micromirror 4 adopts if no current flows. In the first position 6, the micromirror 4 reflects the radiation emitted by the radiation source 2 toward a radiation exit 12, in which an optical unit 14 is arranged. The radiation is here emitted by the micromirror 4 in the shape of a cone, with the radiation broadening in a direction away from the micromirror 4. In the second position 8, the micromirror 4 reflects the radiation emitted by the radiation source 2 toward an absorber 16, or beam dump. In the third position 10, the radiation from the radiation source is emitted from the micromirror 4 in a direction between the optical unit 14 and the absorber 16. Such a micromirror device 1 is shown, for example, in

The radiation source 2 is, for example, one or more radiation sources using LARP technology or one or more LEDs or a combination of LEDs and radiation sources using LARP technology. It is furthermore feasible for the radiation source 2 to be configured in the form of a matrix system, for example as a combination of LARP light sources and LED light sources. The radiation source in combination with the micromirror device 1 results in a high resolution of radiation emitted by way of the optical unit 14, the temporal and spatial intensity distribution of which is flexibly settable.

According to FIG. 1, the micromirror 4 is able to be panned in an angular range or acceptance angle range such that three different states are provided in the angle space. One state is the coupling-out of the radiation from the radiation source 2 via the optical unit 14 or secondary optical unit if the micromirror 4 is in its first position 6. A state that is unused according to FIG. 1 is present if the micromirror 4 is arranged in its third position 10 or if it is located between the positions 6 and 8 as it moves or is in the switched-off state. A further state is provided if the micromirror 4 is in its second position 8, and thus the radiation from the radiation source 2 is blocked by way of the absorber 16. It is thus possible using the micromirror 4 to reflect the radiation from the radiation source 2 toward the optical unit 14 or toward the absorber 16.

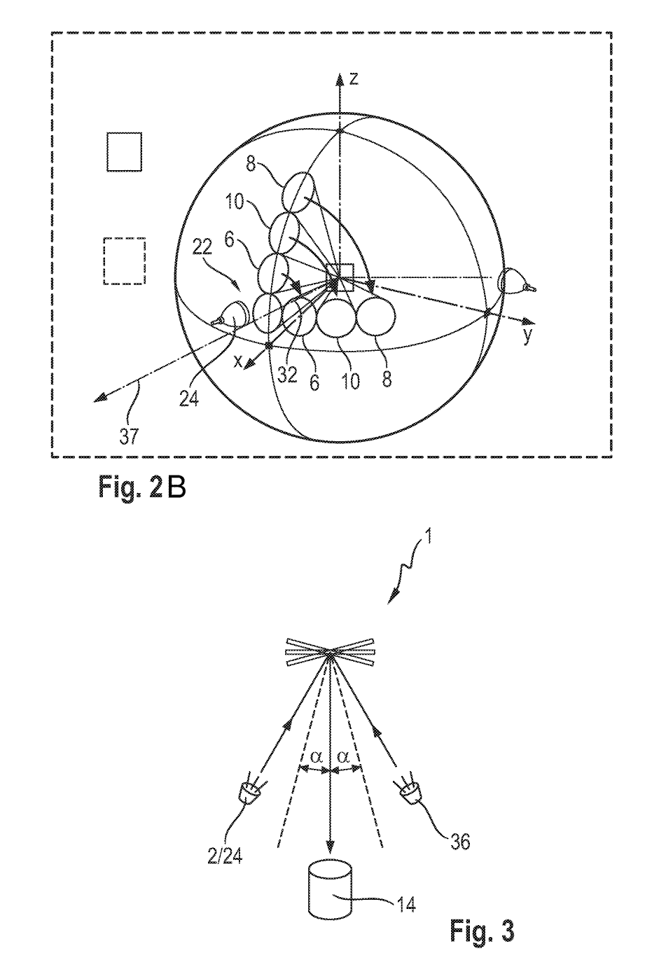

Provision is made according to FIG. 2a for the micromirror device 1 with its multiplicity of micromirrors to move or pivot about an axis 18. The axis 18 can be a z-axis which can extend approximately in a vertical direction or in an up-down direction or in a driving direction of a vehicle. By panning the micromirror device 1 about the axis 18, it can thus be moved or switched between a first position 20 and a second position 22. In the first position 20, the micromirror device 1 is used for the radiation source 2, and in the second position 22, the micromirror device 1 is used for a further, second radiation source 24. In its respective position 20 or 22, the micromirror device 1 can be moved in each case with its micromirrors 4 into the positions 6, 8 and 10 described in FIG. 1.

The first radiation source 2 is, for example, a radiation source that emits visible radiation, and the second radiation source 24 is a radiation source that emits infrared radiation (IR radiation). If the micromirror device 1 is thus moved toward the first radiation source 2, that is to say into its first position 20, the light-emitting arrangement 26 from FIG. 2 can be used for an illumination function, such as for example a low beam or high beam of a vehicle. In contrast, if the micromirror device 1 is moved toward the second radiation source 24, that is to say into its second position, the light-emitting arrangement 26 can be used for example for a night vision function. A sensor 28 that captures the IR radiation reflected by the environment can be additionally provided for the night vision function. The sensor 28 can also be located in the vehicle outside of the vehicle headlight 35.

According to FIG. 2a, the light-emitting arrangement 26 can have a common optical unit 30 for both radiation sources 2, 24, which is shown schematically in FIG. 2. An optical unit 30 can also be provided for a respective radiation source 2 or 24.

The micromirror device 1 is furthermore movable or pivotable in a respective position 20 and 22 about a further axis 32. As a result, an emission surface 34 of the micromirror device 1 can be moved in the respective position 20 and 22. The axis 32 is, in the first position 20, the radiation axis of the first radiation source 2, and in the second position 22 it is the radiation axis of the second radiation source 24. It is feasible that, during the movement of the emission surface 34 in a respective position 20 and 22, the respective radiation source 2, 24 is also moved or also pivoted or pivoted or moved.

Provision can generally be made for the micromirror device to be pivoted about one or more axes which are able to be defined in arbitrary fashion. Provision can e.g. be made for the micromirror device to be pivoted about one or more main axes, which are defined by the optical units and the illumination. According to FIG. 2, the main axes can be the axis 18 (z-axis) and/or the x-axis and/or y-axis. It is furthermore feasible for the micromirror device, in the respective position in which it can be pivoted, to be pivotable in each case about at least one further axis, as will be explained below in FIG. 2b, in order e.g. to change an orientation of the emission surface in the respective position.

According to FIG. 2a, the light-emitting arrangement 26 is part of a vehicle headlight 35, which is illustrated schematically by way of a dashed line.

If an LCoS is used instead of the micromirror device 1, it is feasible for the radiation sources 2 and 24 to emit polarized radiation.

FIG. 2b shows the pivoting or movement or tilting of the micromirror device 1 within the position 22. The device is here pivotable about an axis 37 which in this embodiment extends approximately coaxially with respect to the axis 32 of the radiation source 24. A beam axis of the conical radiation in the positions 6, 10 and 8 of the micromirror 4 from FIG. 1 extends, after tilting, in a different plane. This is approximately a horizontal plane in FIG. 2b, while in the non-tilted state, approximately a vertical plane is provided.

FIG. 3 shows a further development of the light-emitting arrangement 26 from FIG. 2. Here, a further, third radiation source 36 is assigned to the micromirror device 1 in the first position 20 and/or in the second position 22 in addition to the radiation source 2 and/or 24. The third radiation source 36 is here arranged such that its radiation in the second position 8 (off state), see FIG. 1, radiates toward the optical unit. It is thus possible, for example in the first position 20 of the micromirror device 1 from FIG. 2, for the radiation sources 2 and 36 to be used in alternation or also approximately simultaneously. Alternatively or additionally, this also applies to the second position 22, in which a further radiation source is able to be used in addition to the radiation source 24.

Disclosed is a light-emitting arrangement having a micromirror device which is able to be panned and/or tilted and/or pivoted, as a device in its entirety, into at least two positions. At least one radiation source is assigned to the micromirror device in a respective position.

### LIST OF REFERENCE SIGNS

micromirror device 1

radiation source 2

micromirror 4

first position 6

second position 8

third position 10

radiation exit 12

optical unit 14

absorber 16

axis 18

first position 20

second position 22

radiation source 24

light-emitting arrangement 26

sensor 28

optical unit 30

axis 32

emission surface 34

third radiation source 36

axis 37

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A light-emitting arrangement, comprising:
a first radiation source, in a beam path of which a micromirror device is arranged to where radiation emitted by the first radiation source may be directed at least into a first direction and a second direction,
at least a second radiation source configured to emit radiation toward the micromirror device, wherein the radiation from the second radiation source may be directed, via the micromirror device, at least into a first and a second direction, wherein the micromirror device is movable about at least one axis into at least two positions.

2. The light-emitting arrangement of claim 1, further comprising:
a common optical unit for the radiation sources downstream of the micromirror device.

3. The light-emitting arrangement of claim 1, further comprising:
one optical unit provided downstream of the micromirror device for each radiation source.

4. The light-emitting arrangement of claim 1,
wherein the first radiation source is configured for a first light-emitting function, and the second radiation source is configured for a second light-emitting function.

5. The light-emitting arrangement of claim 1,
wherein the first radiation source and at least the second radiation source are configured for the same light-emitting function.

6. The light-emitting arrangement of claim 1,
wherein one or more of the first radiation source or the second radiation source is configured to provide an illumination function or a signal-light function.

7. The light-emitting arrangement of claim 1,
wherein one or more of the first radiation source or the second radiation source is configured to provide a night vision function.

8. The light-emitting arrangement of claim 1,
wherein one or more of the first radiation source or the second radiation source is configured to emit radiation at least substantially in the visible range in the form of light radiation or to emit radiation substantially in the ultraviolet range in the form of UV radiation.

9. The light-emitting arrangement of claim 1,
wherein one or more of the first radiation source or the second radiation source is configured to emit radiation at least substantially in the infrared range in the form of infrared radiation.

10. The light-emitting arrangement of claim 9, further comprising:
a sensor configured to capture infrared radiation emitted by one or more of the first radiation source or the second radiation source and is reflected by an environment.

11. The light-emitting arrangement of claim 4,
wherein the first light-emitting function is provided in a first position and the second light-emitting function is provided in a second position.

12. The light-emitting arrangement of claim 11,
wherein the micromirror device is moved between the positions at a frequency or speed such that a plurality of light-emitting functions are able to be used approximately simultaneously.

13. The light-emitting arrangement of claim 12,
wherein the frequency or speed is chosen such that a switch between the light-emitting functions is not able to be perceived by a human eye.

14. The light-emitting arrangement of claim 10,
wherein the sensor is configured to be activated only together with one of the radiation sources.

15. The light-emitting arrangement of claim 11,
wherein the sensor is configured to be activated only in one of the positions.

16. The light-emitting arrangement of claim 1,
wherein the micromirror device is configured to be panned about at least one further axis in order to move an emission surface of the micromirror device.

17. A vehicle headlight, comprising:
a light-emitting arrangement, comprising:
a first radiation source, in a beam path of which a micromirror device is arranged to where radiation emitted by the first radiation source may be directed at least into a first direction and a second direction,
at least a second radiation source configured to emit radiation toward the micromirror device, wherein the radiation from the second radiation source may be directed, via the micromirror device, at least into a first and a second direction,
wherein the micromirror device is movable about at least one axis into at least two positions.
